(19) United States
(12) Patent Application Publication
(10) Pub. No.: US 2024/0019557 A1
(43) Pub. Date: Jan. 18, 2024

(54) SEE-THROUGH ASSEMBLY FOR AN ENVIRONMENT SENSOR OF A MOTOR VEHICLE

(71) Applicant: Webasto SE, Stockdorf (DE)

(72) Inventors: Michael HUELSEN, Stockdorf (DE); Magnus SVIBERG, Stockdorf (DE); Maximilian EHRMANN, Stockdorf (DE); Cédric LANGLAIS, Stockdorf (DE)

(21) Appl. No.: 18/218,394

(22) Filed: Jul. 5, 2023

(30) Foreign Application Priority Data
Jul. 14, 2022 (DE) 10 2022 117 608.8

(51) Int. Cl. G01S 7/497; G01S 17/931; B60S 1/02; B60S 1/52; H05B 3/86

(52) U.S. Cl. CPC G01S 7/497; G01S 17/931; B60S 1/026; B60S 1/52; H05B 3/86; G01S 2007/4977; H05B 2214/02

(57) ABSTRACT

A see-through assembly for an environment sensor of a motor vehicle, the see-through assembly having at least one see-through area, a control feature, and a cleaning feature for cleaning the see-through area. The cleaning feature has a membrane spaced apart from an outer surface of the see-through area by a layer, or the see-through area has a shape-changing and/or volume-changing and/or thickness-changing excitation layer at least on its outer surface, the control feature being configured to cause the membrane to move in a predetermined manner relative to the outer surface of the see-through area or to cause the shape-changing and/or volume-changing and/or thickness-changing excitation layer to move in a predetermined manner so that foreign particles located on an outer surface of the membrane can be loosened and/or detached and/or removed.

### CROSS-REFERENCE TO RELATED APPLICATION

This application claims priority from German Patent Application Number 10 2022 117 608.8, filed on Jul. 14, 2022, which is hereby incorporated herein by reference in its entirety for all purposes.

### FIELD

The invention relates to a see-through assembly for an environment sensor of a motor vehicle. Furthermore, the invention relates to a roof module comprising at least one such see-through assembly. Also, the present invention relates to a motor vehicle comprising at least one such see-through assembly. A generic see-through assembly comprises a see-through area, a control feature and a cleaning feature for cleaning the see-through area.

### BACKGROUND

Generic cleaning features are used, for example, in motor vehicles and also in roof modules for such motor vehicles for cleaning see-through areas, such as a front and/or a rear window and/or a see-through area of an environment sensor and/or headlights.

Roof modules are widely used in vehicle manufacturing since these roof modules can be prefabricated as separate functional modules and can be delivered to the assembly line when assembling the vehicle. The roof module at least partially forms a roof skin of the vehicle roof at its outer surface, the roof skin preventing moisture and air flows from entering the vehicle interior. The roof skin is composed of one or more panel components, which can be made of a stable material, such as painted metal or painted or solid-colored plastic. The roof module can be a part of a fixed vehicle roof or a part of an openable roof sub-assembly.

Furthermore, the development in vehicle manufacturing is increasingly focusing on autonomously and semi-autonomously driving motor vehicles. So as to enable the vehicle controller to control the motor vehicle autonomously or semi-autonomously, a plurality of environment sensors (e.g., lidar sensors, radar sensors, (multi-)cameras, etc. including other (electrical) components) are employed, which are integrated in the roof module, for example, and which detect the environment surrounding the motor vehicle and determine, for example, a current traffic situation from the acquired environment data. Roof modules which are equipped with a plurality of environment sensors are also known as roof sensor modules (RSM). The known environment sensors send and/or receive electromagnetic signals, such as laser beams or radar beams, allowing a data model of the vehicle environment to be generated by signal evaluation and to be used for controlling the vehicle.

The environment sensors for monitoring and detecting the vehicle environment are typically located on the vehicle roof since the vehicle roof is usually the highest point of a vehicle, from where the vehicle environment is easily visible. The sensor modules are placed on top of the panel component of the roof module forming the roof skin. When the environment sensor is in use, ambient conditions (e.g., weather conditions) pose the risk that a see-through area that is partially transparent or transparent for the environment sensor may accumulate dirt, which interferes with the signal detection of the environment sensor, or, in the worst case, the see-through area may become opaque for the environment sensor. However, this contradicts the principle that a high and continuous availability of the environment sensors and the signals generated by them is required for the best possible operation, reliability and availability of the autonomous or semi-autonomous driving mode.

To partially solve this problem, the use of generic cleaning features for cleaning the see-through area as described above is known. Similar to spray nozzles of a windshield or headlight wiper system, these cleaning features are positioned in an area of the roof module in front of the see-through area in question. As cleaning fluid, for example, an aqueous soap solution or a compressed gas, such as compressed air, can be sprayed, cleaning by means of compressed air having the advantage over cleaning by means of an aqueous soap solution that no cleaning waste water has to be removed from the cleaned surface and/or from the roof module after cleaning. Cleaning features in which cleaning is performed by wiper elements, often supported by fluid-based pre-cleaning, are also known.

In the state of the art, a cleaning process for cleaning a see-through area is often actively controlled by a vehicle occupant, as is also known from cleaning the front and/or rear windows and/or headlights. In this case, the vehicle occupant activates the cleaning feature manually via a lever and/or a control element, for example, which starts a cleaning process. In most cases, the cleaning process continues until the occupant releases the control element and/or a predetermined period of time has elapsed. It is also known to indicate to the occupant that cleaning of a certain see-through area is necessary because of a determined amount of accumulated dirt so that the occupant can activate the cleaning process in response. It is also known to automatically activate cleaning as a function of a determined amount of accumulated dirt on the see-through area, similar to what is typically already known for the activation of windshield wipers.

Both the automatic and the manual activation of known cleaning features have the disadvantage that cleaning does not take place optimally under all ambient conditions, which means an optimal cleaning result cannot be achieved depending on the ambient conditions and/or the driving situation. In the state of the art, for example, it is possible in particular under varying ambient conditions that dirt residue remains on the see-through area in question after a cleaning process has been carried out, as said dirt residue adheres strongly to the see-through area because of high solar radiation, for example. This makes it necessary to repeat the cleaning process, which may result in an excessive increase in the amount of cleaning fluid required. This in turn increases the costs incurred for cleaning. In addition, insufficient cleaning has a negative effect on the availability of an environment sensor in question with the result that vehicle safety is also negatively affected. Also, a cleaning effectiveness of known cleaning systems in removing larger contaminants and/or caked-on contaminants, for example after a collision with an insect, is often insufficient.

### SUMMARY

Due to the aforementioned disadvantages, an object of the invention is to propose a see-through assembly comprising a cleaning feature and/or a roof module comprising such a see-through assembly and/or a motor vehicle comprising such a see-through assembly by which the aforementioned disadvantages from the state of the art are reduced and in particular an optimized cleaning of a see-through area can take place.

The object is attained by a see-through assembly according to the teaching of claim 1. Furthermore, the object is attained by a roof module according to claim 12. Furthermore, the object is attained by a motor vehicle according to at least one of claims 13 and 14.

Advantageous embodiments of the invention are the subject matter of the dependent claims. Moreover, any and all combinations of at least two features disclosed in the description, the claims, and/or the figures fall within the scope of the invention. Naturally, the explanations given in connection with the see-through assembly equivalently relate to the roof module and/or the motor vehicle according to the invention without being mentioned separately in its context. Likewise, any and all features and embodiments disclosed in the context of the see-through assembly equivalently, albeit not verbatim, relate to a cleaning method according to the invention which can be claimed based on the mode of operation of the cleaning feature. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

The see-through assembly according to the invention for an environment sensor of a motor vehicle comprises at least one see-through area, a control feature, and a cleaning feature for cleaning the see-through area. The cleaning feature has a membrane spaced apart from an outer surface of the see-through area by a layer. Alternatively, the see-through area comprises a shape-changing and/or volume-changing and/or thickness-changing excitation layer at least on its outer surface, in particular an excitation layer comprising a shape memory material. The see-through area can preferably be formed by the excitation layer. The control feature is configured to cause the membrane to move in a predetermined manner relative to the outer surface of the see-through area or to cause the shape-changing and/or volume-changing and/or thickness-changing excitation layer to move in a predetermined manner so that foreign particles located on an outer surface of the membrane can be loosened and/or broken up and/or detached and/or removed, in particular “shaken off”.

In another aspect, the invention relates to a roof module for forming a vehicle roof on a motor vehicle, the roof module comprising a panel component which at least partially forms a roof skin of the vehicle roof, the roof skin serving as an outer sealing surface of the roof module, at least one see-through assembly according to any one embodiment of the invention, and at least one environment sensor configured to send and/or receive electromagnetic signals at least through the see-through area so as to detect a vehicle environment, the see-through area being disposed on the panel component or integrated in the panel component or the see-through area being disposed on a housing of the at least one environment sensor or integrated in the housing of the at least one environment sensor. Of course, the environment sensor can also look through multiple see-through areas disposed one behind the other. For example, the environment sensor can be disposed in a housing on which a see-through area is provided. The housing can be covered by the roof skin, which means a further see-through area is preferably provided in the panel component forming the roof skin. In this case, the environment sensor looks through both see-through areas so as to detect the vehicle environment. The housing can also be disposed on the roof module in such a manner that it can be retracted and deployed. In this case, the environment sensor preferably looks only through the see-through area provided on the housing when the housing is in a deployed position. The cleaning feature according to the invention or the membrane comprised therein is preferably disposed at the see-through area which terminates with an outer environment of the roof module and/or the motor vehicle. The same applies to other arrangement positions of an environment sensor in other areas of the motor vehicle and is basically independent of an arrangement in the roof area.

The invention also relates to a motor vehicle comprising a vehicle body and at least one roof module according to the invention, which is disposed on the vehicle body, in particular glued thereto, as a structural unit.

In another aspect, the invention relates to a motor vehicle comprising at least one see-through assembly according to any one embodiment of the invention and at least one environment sensor configured to send and/or receive electromagnetic signals at least through the see-through area so as to detect a vehicle environment.

In another aspect, the invention relates to a method for cleaning at least one see-through area of a motor vehicle using a cleaning feature comprising a movable membrane spaced apart from an outer surface of the see-through area by a layer. Alternatively, the see-through area comprises a shape-changing and/or volume-changing and/or thickness-changing excitation layer at least on its outer surface, in particular an excitation layer comprising a shape memory material. The method comprises at least the step of: causing the at least one membrane to move relative to the outer surface of the see-through area according to a predetermined movement profile, or causing the at least one shape-changing and/or volume-changing and/or thickness-changing excitation layer to move relative to the outer surface of the see-through area according to a predetermined movement profile, so as to loosen and/or detach and/or remove foreign particles located on an outer surface of the membrane. Preferably, the step of causing movement comprises actuating a pump and/or a control valve and/or a compressor so as to preferably reciprocate a fluid forming the fluid layer within the space. Alternatively preferably, the step of causing movement comprises actuating a piezoelectric and/or magnetic-stroke-based and/or vibration-inducing excitation feature coupled to the membrane in a movement-transmitting manner so as to induce a predetermined movement which is transmitted to the membrane.

So the purpose of the invention is in particular to substantially reduce a residence time of foreign particles on the outer surface of the membrane or the excitation layer. Particularly preferably, the foreign particles are removed immediately after impact on the outer surface of the membrane or on the outer surface of the excitation layer by causing the membrane or the excitation layer to move or are at least loosened in such a manner that subsequent removal of the foreign particles by means of a conventional cleaning technique is significantly simplified. In other words, a time it takes to free the see-through area, in particular the outer surface of the membrane or the outer surface of the excitation layer, from foreign particles is shortened according to the invention. Likewise, the effectiveness of freeing the see-through area from foreign particles can be increased. For this purpose, according to the invention, a movable membrane is disposed directly on the see-through area, in particular on a sensor see-through area, for example a sensor window, or on an additional see-through area. Alternatively, the see-through area comprises the excitation layer or is formed by the excitation layer. The membrane is not rigidly connected to the see-through area, in particular to a base material, for example glass and/or a solid plastic, but is preferably separated from it by a fluid layer formed by a fluid. The fluid layer preferably forms a boundary layer between the membrane and the see-through area, on which the membrane “floats”. Alternatively, an elastic and/or foamy and/or spongy solid material may be used as the layer. The fluid can be water, air, a special liquid and/or a special gas, for example. This enables the movement of the membrane to be largely decoupled from the base material of the see-through area. The membrane forms an outer surface of the see-through assembly which is exposed to a vehicle environment and which may be dirty and/or fogged and/or iced and/or snowed due to environmental conditions. By moving the membrane, foreign particles can preferably be loosened and/or removed and/or repelled, in particular “shaken off”, whereby accumulated dirt or a foreign particle load on the see-through area decreases, making a more interference-free signal penetration through the see-through area possible. The movable membrane or its outer surface or the excitation layer can preferably be caused to move by attaching a movement generator and/or an actuator and/or a vibration element to the membrane or the excitation layer in such a manner that a movement of the membrane or the excitation layer is generated. Alternatively, the movable membrane can preferably be caused to move by causing a fluid located in the space between the membrane and the see-through area to move. In response, a movement of the membrane “floating” on the fluid is generated; for example, the membrane undergoes a predetermined movement, such as being at least partially curved in and/or out. The design of the see-through area according to the invention, i.e., the provision of the movable membrane or the excitation layer, has the advantage that a considerably faster and/or more effective cleaning of the outer surface of the see-through assembly from dirt and/or dust and/or mud and/or insects and/or ice and/or snow and/or slush and/or raindrops and/or leaves and/or plant debris and/or crumbs and/or dust and/or moisture and/or other dirt or weathering components is possible. In other words, a higher cleaning effectiveness with respect to the removal of ice and/or snow and/or slush etc. can be achieved by repulsion, in particular a “vibrating off”, possibly supported by a conventional cleaning nozzle and/or a conventional wiper. For instance, it is possible to remove foreign particles loosened by the movement of the membrane by using a cleaning nozzle and/or a wiper element.

The membrane can be made of a plastic material and/or of a plastic mixture. The membrane is preferably transparent. If a lidar sensor is used as an environment sensor, the membrane and/or the excitation layer and/or the see-through area can be basically opaque, in particular black. Particularly preferably, however, the membrane is transparent to wavelengths detectable by the human eye and/or transparent to wavelengths used by an environment sensor and/or transparent to wavelengths emitted by a light source depending on the intended use of the see-through area. The membrane is preferably made of an elastic and mechanically tear-resistant material. For example, polymer membranes are suitable for the application according to the invention. The membrane forms an outer surface of a cover and/or a housing of the environment sensor towards the outside, in particular in the direction of a vehicle environment. The see-through area is preferably not directly exposed to the ambient conditions of the vehicle environment, but is protected from the outside by the membrane. The membrane is preferably disposed in front of the see-through area, as seen in the direction of view of an environment sensor, and is separated from the see-through area by the layer, in particular the fluid layer or a foamy or elastic layer, and is consequently spaced apart from the see-through area. The layer can be made of any fluid or fluid mixture or of a soft, highly elastic material. In principle, the membrane may alternatively or additionally be spaced apart from an outer surface of the see-through area by at least one spacing profile, for example at least one spacing bracket. The distance between the membrane, in particular an inner surface of the membrane, and the see-through area, in particular an outer surface of the see-through area, may be minimal, in particular only a few micrometers to millimeters. The distance is preferably only large enough to still allow the membrane to move relative to the see-through area. The see-through area is preferably fixed in its position, i.e., it is not excited to move. The movability of the membrane is preferably due to a flexibility of its material. The membrane is preferably fixed relative to the see-through area in its edge area and/or along its edge area. The remaining surface of the membrane, however, is preferably movable relative to the see-through area. The membrane may be fixed relative to the frame in its edge region, for example by a frame and/or a spacer and/or via another type of connection. This fixation is preferably fluid-tight with respect to an environment so that no fluid can escape from the space between the see-through area and the membrane. Particularly preferably, the fixation comprises one or more sealing elements. The excitation layer preferably comprises a shape memory material which can be excited to change shape by a control signal and can preferably be returned to its predetermined original shape by a counter control signal. The shape memory material can be excited to change shape by means of an electrical or electromagnetic or mechanical signal, for example. Such materials are known under the term “smart materials”.

In its intended use, the cleaning feature according to the invention may be particularly preferably be used for cleaning a windshield and/or a rear window and/or a headlight and/or a see-through area of an environment sensor and/or any other electrical and/or electronic and/or electromagnetic component disposed on or integrated in a motor vehicle. Preferably, a motor vehicle comprises multiple see-through assemblies according to the invention.

In principle, the see-through area may be a window and/or a lens and/or a headlight cover and/or a window (e.g., a windshield and/or a rear window) disposed on a motor vehicle and being at least partially transparent or fully transparent to a predetermined electromagnetic radiation, for example. The see-through area may preferably be made of a plastic or glass or another at least partially transparent material. In principle, it is possible, for example, that the see-through area is inserted into an opening of the panel component of the roof module according to the invention as a window or lens, through which the at least one environment sensor looks so as to detect the vehicle environment. Alternatively or additionally, it is also possible that the see-through area is integrally formed in such a panel component.

The control feature may in principle be provided at a distance from the remaining components of the see-through assembly at any location of a motor vehicle and/or a roof module. In principle, the control feature can also control the cleaning feature remotely, in particular wirelessly. The control feature may in principle also be included in a camera control unit and/or a sensor control unit.

In a preferred embodiment, the layer comprises a gas and/or a liquid and/or a liquid-solid mixture and/or a gas-solid mixture and/or a flexible and/or elastic and/or foamy and/or spongy solid and/or a shape memory solid which is introduced into a space between the see-through area and the membrane. The space is preferably sealed to the outside in a fluid-tight manner so that the fluid cannot escape from the space. It is understood that a fluid inlet and/or a fluid outlet can be provided, through which the space can be integrated into a preferably self-contained fluid circuit. In this way, it is possible, for example, to pass a fluid and/or a fluid mixture through the space so as to achieve a predetermined movement profile of the fluid in the space. In other embodiments, the space may also be hermetically sealed from an external environment so that no fluid can escape from or enter the space.

In a preferred embodiment, the control feature is configured to cause the membrane to move in an alternating and/or pulsed and/or cycled and/or frequent and/or oscillating and/or vibrating manner, which preferably causes at least part of the membrane to curve convexly and/or concavely relative to the see-through area, which preferably remains motionless, or to cause the excitation layer to move in an alternating and/or pulsed and/or cycled and/or frequent and/or oscillating and/or vibrating manner so as to convexly and/or concavely curve at least part of the excitation layer. Other types of movement and/or movement profiles are also included, which means the listing is to be understood as merely exemplary. In fact, the membrane or the excitation layer can be caused to execute any predetermined and/or situation-optimized movement profile. Preferably, the membrane or the excitation layer can be caused to execute a predetermined movement and/or a predetermined movement profile by causing the membrane or the excitation layer to move directly or indirectly by means of a movement applicator or by causing the membrane to move indirectly by imparting movement to the fluid. In other words, the membrane or the excitation layer can move or can be actuated to move in an alternating and/or oscillating and/or vibrating, etc., manner. Preferably, the movement of the membrane or the excitation layer may also alternate between concave and convex and/or may take place in a predetermined direction perpendicular to the surface, i.e. concave and/or convex, or may also differ across the membrane surface. Depending on the embodiment or the foreign particle load, the control feature may cause the membrane or the excitation layer to execute a fast or slow movement and/or a sequence of movements, possibly at different speeds, i.e., following a predetermined speed profile.

In a preferred embodiment, the control feature is designed to control the movement of the membrane or the excitation layer as a function of a foreign particle quantity and/or a foreign particle distribution, in particular partially selectively. Particularly preferably, the control feature can, for example, set only a partial area of the membrane or the excitation layer, in particular one or more membrane segments or excitation layer segments, in movement, while the remaining membrane or excitation layer remains motionless. This makes it possible to remove partial contaminations and/or foreign particles on the outer surface precisely.

In a preferred embodiment, the cleaning feature comprises at least one cleaning nozzle and/or a wiper element configured to remove foreign particles which are located on the outer surface of the membrane or on the outer surface of the excitation layer and which have been loosened by the membrane movement or the excitation layer movement. The cleaning nozzle and/or the wiper element is/are preferably actuated by the control feature. Particularly preferably, the see-through area can be checked for the presence of foreign particles on the outer surface, which, in the case of an environment sensor, for example, interfere with a signal flow and thus lead to false signals or interference signals. In the case of an environment sensor, signal evaluation can be used to detect where foreign particles are located on the see-through area. In response, the control feature preferably causes the membrane or the excitation layer to move. This is preferably followed by another check to see if the contamination could be removed. If the contamination could not be removed by the movement of the membrane or the excitation layer alone, it is preferred for the control feature to cause the at least one cleaning nozzle and/or the wiper element to be switched on additionally so as to remove the contamination or the foreign particles preferably completely. At least an actuation of the cleaning nozzle can preferably be location-specific, which means that the cleaning nozzle is moved, for example, into a predetermined position so as to clean a predetermined spot on the see-through area or on the outer surface of the membrane or the excitation layer. Thus, the control feature is particularly preferably configured to activate the at least one cleaning nozzle and/or the wiper element as a function of a foreign particle quantity and/or a foreign particle distribution on the outer surface of the membrane. In other words, it is possible that a movement of the membrane or the excitation layer and an application of a cleaning fluid by at least one cleaning nozzle and/or a wiping of the membrane surface or the excitation layer surface by a wiper element are combined. In this case, the cleaning nozzle and/or the wiper element is/are used in a coordinated manner to further increase the cleaning effectiveness.

In a preferred embodiment, the foreign particles comprise organic and/or inorganic particles, in particular dirt particles and/or insects and/or water droplets and/or snow and/or ice crystals.

In a preferred embodiment, the see-through assembly comprises a heating feature configured to heat the see-through area, the control feature preferably being configured to control the heating feature as a function of a foreign particle quantity and/or a foreign particle distribution and/or a membrane movement and/or an excitation layer movement and/or to control the membrane movement or the excitation layer movement as a function of and/or in combination with and/or of a heating capacity and/or a heating time of the heating feature. Instead of completely melting and/or draining ice, snow and/or slush by heating the surface, which always requires a high heating capacity and a relatively long time, such a coating (ice and/or snow and/or slush) can just be loosened and/or broken up and/or detached at the surface of the membrane or at the surface of the excitation layer, which requires much less heating capacity and is effective relatively quickly, i.e., in a few seconds. Immediately afterward, i.e., after a short heating or melting, the contamination can then be removed, for example, by an air blast and/or an air jet and/or by another fluid blast and/or fluid jet (e.g., water or a cleaning solution). As a result, a significantly reduced heating capacity is required for removing ice, snow or slush than in the case where this would be achieved by heating alone and the associated complete melting and draining. Due to the lower heating capacity required, significantly fewer or even no heating wires have to be disposed on the see-through area compared to the state of the art. Alternatively or additionally, the individual heating wires and/or a respective heating coating can be made thinner than in the state of the art since less heating capacity (which depends on the cross-section) is required. The smaller heating wires lead to a reduced optical disturbance for the environment sensor and/or an illumination device. In particular, this improves environment sensor transmission through the see-through area, which in turn has a positive effect on sensor performance. Depending on the size of the see-through area, it may be sufficient to arrange the heating elements around the see-through area, i.e., outside of the actual sensor see-through area. Overall, an optical interference effect caused by the heating feature as a matter of principle is reduced.

In a preferred embodiment, the cleaning feature comprises at least one pump and/or at least one control valve and/or at least one compressor and/or a power source and/or a voltage source and/or an energy source, for example for the excitation of the shape memory material. The control feature is preferably configured to actuate the at least one pump and/or the at least one control valve and/or the at least one compressor so as to move a fluid forming the fluid layer within the space. Particularly preferably, the fluid-filled space located between the see-through area and the membrane comprises at least one inlet and at least one outlet. The control feature is preferably configured to move the fluid through the space so as to cause the membrane to move. The control feature may preferably be configured to cause the fluid to move in an alternating and/or pulsed and/or cycled and/or frequent and/or oscillating and/or vibrating manner. In the case of a liquid fluid, this can be done, for example, by opening and closing the control valve and/or by alternately switching the pump on and off. In the case of a gaseous fluid, this can be done, for example, by opening and closing the control valve and/or by alternately switching the compressor on and off. The movement of the fluid is transmitted to the membrane via the boundary layer between the fluid and the inner surface of the membrane with the result that this indirect excitation preferably causes the membrane to move in an alternating and/or pulsed and/or cycled and/or frequent and/or oscillating and/or vibrating manner.

In a preferred embodiment, the cleaning feature comprises at least one piezoelectric and/or magnetic-stroke-based and/or vibration-inducing excitation feature or a movement applicator coupled to the membrane and/or the layer or the excitation layer in a movement-transmitting manner. The control feature is preferably configured to cause the at least one piezoelectric and/or magnetic-stroke-based and/or vibration-inducing excitation feature to execute a predetermined movement. The movement of the excitation feature is preferably transmitted first to a fluid of the layer and thereby to the membrane by the coupling, or directly to the membrane or the excitation layer by the coupling with the membrane or the excitation layer. The excitation feature thus causes or initiates the predetermined movement of the membrane or the excitation layer. For example, the excitation feature may be configured to vibrate and/or execute another movement that is transmitted to the fluid and/or to the membrane or the excitation layer in the form of sound waves. If the excitation feature is coupled directly to the membrane or the excitation layer, its movement is preferably transmitted directly to the membrane or the excitation layer, which means no loss occurs due to an intermediate media transmission. The excitation feature may comprise an electromagnetic vibration element and/or at least one piezo actuator, for example. Alternatively or additionally, the excitation feature may comprise at least one transistor and/or a capacitor and/or other electromagnetic switching elements.

Of course, the embodiments and the illustrative examples mentioned above and yet to be discussed below can be realized not only individually but also in any combination with each other without departing from the scope of the present invention. Moreover, the embodiments and the illustrative examples mentioned above and yet to be discussed below equivalently or at least similarly relate to all embodiments of the invention without being mentioned separately in each context.

### BRIEF DESCRIPTIONS OF THE DRAWINGS

Embodiments of the invention are schematically illustrated in the drawings and will be discussed as examples below.

FIG. 1 is a schematic view of a motor vehicle with a vehicle body and a roof module with a see-through assembly according to the invention;

FIG. 2 shows an illustrative example of a cleaning feature according to the invention;

FIG. 3 shows an illustrative example of a cleaning feature according to the invention;

FIG. 4 is a detailed view of a cleaning feature according to the invention;

FIG. 5 is a detailed view of a cleaning feature according to the invention;

FIG. 6 is a detailed view of a cleaning feature according to the invention; and

FIG. 7 is an illustration according to the state of the art.

### DETAILED DESCRIPTION

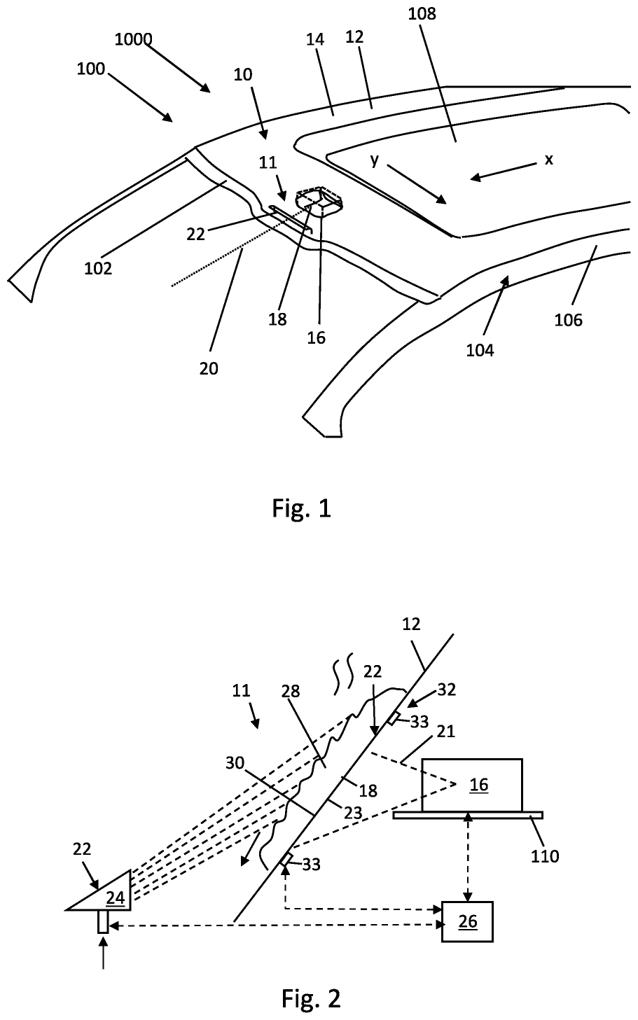

FIG. 1 shows a vehicle roof 100 of a motor vehicle 1000 comprising a roof module 10. The roof module 10 comprises a panel component 12 for forming a roof skin 14 of the vehicle roof 100. An environment sensor 16 is disposed symmetrically to a longitudinal vehicle direction x in a front area of the vehicle roof 100 or the roof module 10 as viewed in the longitudinal vehicle direction x. The environment sensor 16 is disposed directly behind a front transverse rail 102, which defines a header at the roof of the vehicle. The roof module 10 is preferably disposed in a roof frame 104 of the vehicle 1000 or placed on two transverse rails 102 and two longitudinal rails 106, which form the roof frame 104, as a structural unit. The roof module 10 in the embodiment shown has a panoramic roof 108. The longitudinal vehicle direction x is oriented orthogonally to a vehicle width direction y, as shown in FIG. 1.

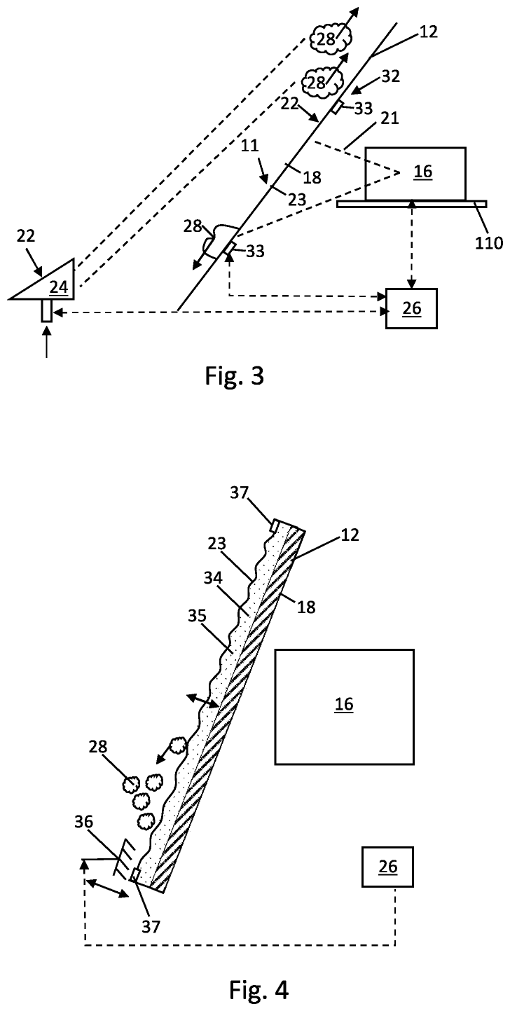

According to the invention, the roof module 10 or the motor vehicle 1000 comprises a see-through assembly 11. The environment sensor 16 looks through a see-through area 18 of the see-through assembly 11. The see-through area 18 is provided on a housing 17 of the environment sensor 16. Alternatively or additionally, such a see-through area 18 may be disposed on or formed by the panel component 12 (see FIGS. 2 to 6). The see-through area 18 can be made of a preferably shatter-proof plastic or glass or another (partially) transparent material, for example. According to FIG. 1, the environment sensor 16 is disposed in an opening of the roof skin 14 and can be retracted and deployed together with its housing 17, the drive mechanism used not being described in detail. In the case at hand, the environment sensor 16 is a lidar sensor configured send and/or receive electromagnetic signals so as to detect the vehicle environment through the see-through area 18. Other sensor types, e.g., (multidirectional) cameras, ultrasonic sensors, laser sensors, radar sensors, etc. can also be used. The see-through assembly 11 according to the invention can also be used for other electrical and/or electromagnetic and/or electromechanical components, such as a light source and/or an antenna and/or an antenna module, alternatively or in addition to the environment sensor 16. The environment sensor 16 is aligned along an optical axis 20, which is aligned parallel to the longitudinal vehicle direction x in the case of FIG. 1. The environment sensor 16 comprises a field of view 21 (see FIGS. 2 and 3) which extends in an essentially conical shape around the optical axis 20 and in which the environment sensor 16 can detect the environment of the vehicle 1000. In the present case, the environment sensor 16 is disposed on a frame structure 110.

According to the invention, the see-through assembly 11 comprises a cleaning feature 22. According to the invention, the cleaning feature 22 comprises a membrane 23 and advantageously at least one cleaning nozzle 24 and an evaluation and control feature 26.

Furthermore, the see-through assembly 11 comprises a control feature 26, which is communicatively connected to the at least one cleaning nozzle 24 and to the environment sensor 16 via one or more cables or wirelessly in the case at hand. In this way, sensor signals and/or control commands can be communicated between the respective components, for example. The control feature 26 is configured to cause the membrane 23 to move in a predetermined manner relative to the see-through area 18 so that foreign particles 28 located on an outer surface 30 of the membrane 23 can be loosened and/or detached and/or removed. The foreign particles 28 may be organic and/or inorganic particles, in particular dirt particles and/or insects and/or water droplets and/or snow and/or ice crystals, for example. In FIG. 2, the foreign particles 28 form a layer of ice on the see-through area 18, that is, the outer surface 30 of the membrane 23. Due to this ice layer, the view through the see-through area 18 is disturbed and possibly no longer possible for the environment sensor 16, which means cleaning and/or de-icing of the see-through area 18 is necessary.

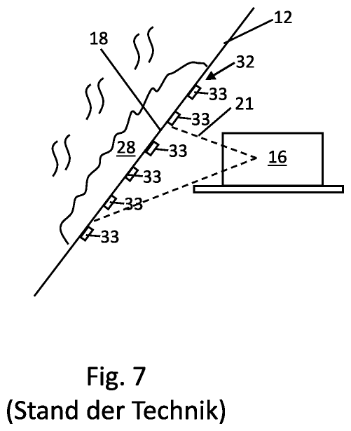

In the state of the art, a heating feature 32 is used for this purpose (see FIG. 7), for example. In the state of the art, this heating feature 32 comprises a large number of heating wires which run within the see-through area 18 and basically act as a disturbance variable for the environment sensor 16. However, this is a necessary evil which had to be accepted since otherwise the see-through area 18 could not be de-iced.

According to the invention, the heating feature 32 can comprise significantly fewer heating wires 33 compared to the state of the art since the movable membrane 23 of the cleaning feature 22 is available for cleaning and/or de-icing in addition to the heating feature 32. In the case of FIGS. 2 and 3, heating wires 33 are provided only in a peripheral area of the see-through area 18 and do not interfere with the field of view 21 of the environment sensor 16. The heating capacity is nevertheless sufficient since the ice only needs to be thawed. Afterwards, the ice can be shaken off and preferably removed by the excitation of the membrane movement. The removal of the ice can be supported, for example, by the optional cleaning nozzle 24, which particularly preferably sprays a heated cleaning fluid onto the ice layer and thus thaws it further and/or even removes the loosening ice pieces. The control feature 26 is preferably also connected to the heating feature 32. In FIG. 3 shows a cleaning stage at which the ice layer has dissolved and only the foreign particles 28 have yet to be removed from the see-through area 18, that is, the outer surface 30 of the membrane 23. This removal can also be done by a position-specific actuation of the cleaning nozzle 24. For this purpose, the cleaning nozzle 24 can, for example, be rotated about or moved along one or more axes in order to spray a predetermined position on the see-through area 18 or even outside the see-through area 18 with cleaning fluid (see FIG. 3, for example). This location-specific control of the cleaning nozzle 24 can preferably be performed in feedback with the evaluation of the sensor signal generated by the environment sensor 16, in which the foreign particles 28 are preferably detected as location-specific interference signals. Since it is possible to evaluate from the sensor signal where exactly a contamination is located on the see-through area 18, it is possible to direct the cleaning fluid sprayed by the at least one cleaning nozzle 24 at this location in a location-specific manner so as to remove the foreign particles 28 in question. Such a location-specific control is preferably also provided with respect to the control of the membrane movement, which will be discussed in further detail below.

FIGS. 4 to 6 each show detailed views of the see-through assembly 11 according to the invention with the cleaning feature 22 according to the invention. The preferably provided heating feature is not shown in the Figures, but may be present in other exemplary embodiments. The cleaning feature 22 comprises the membrane 23, which is spaced apart from a surface of the see-through area 18 by means of a layer 34, presently a fluid layer. Alternatively, the see-through area may also comprise an excitation layer at least on its outer surface, the excitation layer being configured to undergo a shape and/or volume and/or thickness change in response to a control signal. Alternatively, the see-through area may also be formed by the excitation layer. The control feature 26 is configured to impart a predetermined movement to the membrane 23 relative to the see-through area 18 so that the foreign particles 28 located on the outer surface 30 of the membrane 23 can be loosened and/or detached and/or removed. The movability of the membrane 23 is exemplified by means of a double arrow. The fluid layer 34 comprises a gas and/or a liquid and/or a liquid/solid mixture, which is introduced into a space 35 between the see-through area 18 and the membrane 23 and forms the fluid layer 34 there. Alternatively or additionally, the layer 34 may comprise an elastic and/or very soft, movable material. Alternatively or additionally, the layer 34 may comprise a solid/fluid mixture and may in particular be foamy and/or spongy and/or porous.

The control feature 26 is configured to cause the membrane 23 to undergo an alternating and/or pulsed and/or cycled and/or frequent and/or oscillating and/or vibrating and/or abrupt and/or erratic and/or explosive movement, which preferably causes the membrane 23 to curve relative to the see-through area 18 at least regionally and/or multiply convexly and/or multiply concavely. The control feature 26 is configured to control the movement of the membrane 23 as a function of a foreign particle quantity and/or a foreign particle distribution, in particular partially selectively.

The movement of the membrane 23 relative to the unmoved see-through area 18 according to the invention can be enabled in various ways. For example, the cleaning feature 22 may comprise at least one piezoelectric and/or magnetic-stroke-based and/or vibration-inducing excitation feature 36 coupled to the membrane 23 and/or the fluid or the fluid layer 34 in a movement-transmitting manner. The control feature 26 is configured to cause the at least one piezoelectronic and/or magnetic-stroke-based and/or vibration-inducing excitation feature 36 to execute a predetermined movement and/or a predetermined movement profile, which in turn causes the predetermined movement of the membrane 23 indirectly via the fluid being set in motion or directly via the movement coupling with the excitation feature 36. In the present case, the membrane 23 is connected to the see-through area 18 via a frame element 37 at the edge, but can move relative to the see-through area 18 in at least one degree of freedom in the remaining free area.

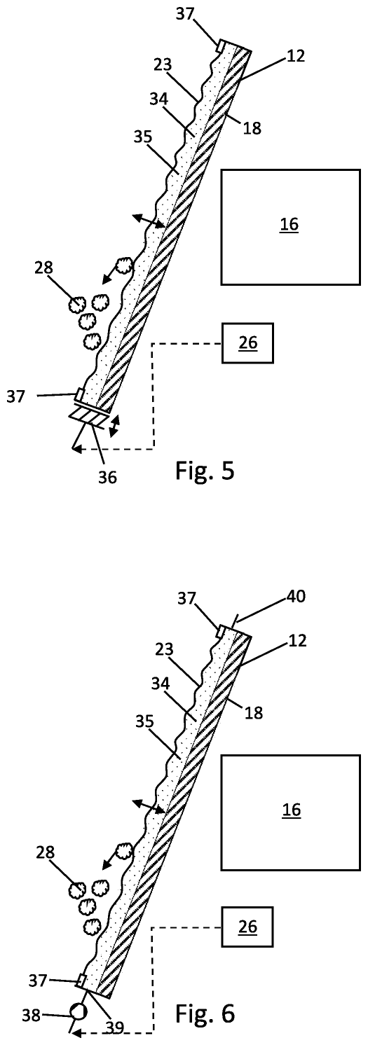

FIG. 4 shows an example of a piezoelectronic excitation feature 36 which can directly excite the membrane 23 to move. The excitation feature 36 is shown enlarged. In FIG. 5, a magnetic-stroke-based excitation feature 36 is shown, by which the fluid or the fluid layer 34 can be set in motion, thereby exciting the membrane 23 to move.

In the embodiment shown in FIG. 6, the cleaning feature 22 includes at least one pump 38. The control feature 26 is configured to actuate the at least one pump 38 so as to move a fluid forming the fluid layer 34 within the space 35. Alternatively or in addition to the pump 38, at least one control valve and/or at least one compressor may be used. The fluid-filled space 35 may comprise at least one inlet 39 and at least one outlet 40. The control feature 26 is designed to move the fluid through the space 35 so as to cause the movement of the membrane 23.

1. A see-through assembly for an environment sensor of a motor vehicle, the see-through assembly comprising:
at least one see-through area,
a control feature, and
a cleaning feature for cleaning the see-through area,
wherein the cleaning feature has a membrane which is spaced apart from an outer surface of the see-through area by a layer, or in that the see-through area comprises a shape-changing and/or volume-changing and/or thickness-changing excitation layer at least on its outer surface, the control feature being configured to cause the membrane to move in a predetermined manner relative to the outer surface of the see-through area or to cause the shape-changing and/or volume-changing and/or thickness-changing excitation layer to move in a predetermined manner so that foreign particles located on an outer surface of the membrane can be loosened and/or detached and/or removed.

2. The see-through assembly according to claim 1, wherein the layer comprises a gas and/or a liquid and/or a liquid/solid mixture and/or a gas/solid mixture and/or a flexible and/or elastic and/or foamy and/or spongy solid and/or a shape memory solid which is/are introduced into a space between the see-through area and the membrane.

3. The see-through assembly according to claim 1, wherein the control feature is configured to cause the membrane to move in an alternating and/or pulsed and/or cycled and/or frequent and/or oscillating and/or vibrating manner, which causes at least part of the membrane to curve convexly and/or concavely relative to the see-through area, or to cause the excitation layer to move in an alternating and/or pulsed and/or cycled and/or frequent and/or oscillating and/or vibrating manner so as to convexly and/or concavely curve at least part of the excitation layer.

4. The see-through assembly according to claim 1, wherein the control feature is configured to control the movement of the membrane or the excitation layer, partially selectively, as a function of a foreign particle quantity and/or a foreign particle distribution.

5. The see-through assembly according to claim 1, wherein the cleaning feature comprises at least one cleaning nozzle and/or a wiper element configured to remove foreign particles which are located on the outer surface of the membrane or on the outer surface of the excitation layer and which have been loosened by the movement of the membrane or the movement of the excitation layer.

6. The see-through assembly according to claim 5, wherein the control feature is configured to activate the at least one cleaning nozzle and/or the wiper element as a function of a foreign particle quantity and/or a foreign particle distribution on the outer surface of the membrane or on the outer surface of the excitation layer.

7. The see-through assembly according to claim 1, wherein the foreign particles comprise organic and/or inorganic particles, dirt particles and/or insects and/or water droplets and/or snow and/or ice crystals.

8. The see-through assembly according to claim 1, wherein the see-through assembly comprises a heating feature configured to heat the see-through area, the control feature configured to control the heating feature as a function of a foreign particle quantity and/or a foreign particle distribution and/or a membrane movement and/or an excitation layer movement and/or to control the membrane movement or the excitation layer movement as a function of a heating capacity and/or a heating time of the heating feature.

9. The see-through assembly according to claim 1, wherein the cleaning feature comprises at least one pump and/or at least one control valve and/or at least one compressor, and the control feature is configured to actuate the at least one pump and/or the at least one control valve and/or the at least one compressor so as to move a fluid forming the fluid layer within the space.

10. The see-through assembly according to claim 9, wherein the fluid-filled space comprises at least one inlet and at least one outlet, and the control feature is configured to move the fluid through the space so as to cause the membrane to move.

11. The see-through assembly according to claim 1, wherein the cleaning feature comprises at least one piezoelectric and/or magnetic-stroke-based and/or vibration-inducing excitation feature coupled to the membrane and/or the layer or the excitation layer in a movement-transmitting manner, the control feature configured to cause the at least one piezoelectric and/or magnetic-stroke-based and/or vibration-inducing excitation feature to execute a predetermined movement which causes the predetermined movement of the membrane and/or the layer or the excitation layer.

12. A roof module for forming a vehicle roof on a motor vehicle, the roof module comprising:
a panel component which at least partially forms a roof skin of the vehicle roof,
the roof skin serving as an outer sealing surface of the roof module,
at least one see-through assembly according to claim 1, and at least one environment sensor configured to send and/or receive electromagnetic signals at least through the see-through area so as to detect a vehicle environment,
the see-through area being disposed on the panel component or integrated in the panel component, or the see-through area being disposed on or integrated in a housing of the at least one environment sensor.

13. A motor vehicle comprising a vehicle body and a roof module according to claim 12, the roof module being disposed on the vehicle body as a structural unit.

14. A motor vehicle comprising at least one see-through assembly according to claim 1 and at least one environment sensor configured to send and/or receive electromagnetic signals at least through the see-through area so as to detect a vehicle environment.

15. A method for cleaning at least one see-through area of a motor vehicle using a cleaning feature comprising a movable membrane spaced apart from an outer surface of the see-through area by a layer, or that the see-through area comprises a shape-changing and/or volume-changing and/or thickness-changing excitation layer at least on its outer surface, the method comprising at least the step of:
causing the at least one membrane to move in such a manner that it moves according to a predetermined movement profile relative to the outer surface of the see-through area, or
causing the at least one shape-changing and/or volume-changing and/or thickness-changing excitation layer to move in such a manner that it moves according to a predetermined movement profile relative to the outer surface of the see-through area so as to loosen and/or detach and/or remove foreign particles located on an outer surface of the membrane.

16. The see-through assembly according to claim 1, wherein the excitation layer comprises a shape memory material.

17. The method according to claim 15, wherein the excitation layer comprises a shape memory material.
